(19) United States
(12) Patent Application Publication
(10) Pub. No.: US 2017/0194108 A1
(43) Pub. Date: Jul. 6, 2017

(54) ADJUSTABLE CONTACTOR

(71) Applicant: Schneider Electric Industries SAS, Rueil-Malmaison (FR)

(72) Inventors: Yuanzhong WANG, Shanghai (CN); Yixu WANG, Shanghai (CN); Francois CHAUDOT, Mendes (FR)

(73) Assignee: Schneider Electric Industries SAS, Rueil-Malmaison (FR)

(21) Appl. No.: 15/392,780

(22) Filed: Dec. 28, 2016

(30) Foreign Application Priority Data
Dec. 30, 2015 (CN) ZL201521131998.5

(51) Int. Cl. H01H 1/50; H01H 3/38

(52) U.S. Cl. CPC H01H 1/50; H01H 3/38; H01H 2235/01

(57) ABSTRACT

The present utility model discloses an adjustable contactor comprising: a static contact fixed in the contactor; a movable contact which is connected in the movable contact bracket through a contact spring, and which makes contact with the static contact in accordance with the movement of the movable contact bracket in the contactor; the contactor further comprises adjusting knobs provided in the movable contact bracket at one end in connection with the contact spring while corresponding to the contact springs connected with individual movable contacts, the adjusting knob being set so that adjustment of the compression or release of the contact spring is achieved by rotating the adjusting knob so as to adjust the contact pressure of the movable contact.

### BACKGROUND

The present utility model relates to an adjustable contactor.

In a conventional contactor, a circuit is closed by bringing the movable contact and the static contact into contact. However, the contact pressure between the movable contact and the static contact is critical to the electrical shock stability. To ensure a good contact, it is necessary to ensure a considerable contact pressure. In general, a certain overtravel is required in the design of the movable contact and the static contact, which means the compression stroke of the contact spring after the contact of the movable contact with the static contact. The overtravel can ensure that a certain contact pressure can still be kept for the contact even after its electrical wear, and due to the cushioning made by the contact spring force, the bounce is depressed, and a certain initial kinetic energy can be obtained by the contact when the contact is opened.

If the overtravel is too small, it can not guarantee the contact pressure necessary for the contact after its electrical wear, and at the same time, the initial opening velocity becomes smaller, which would affect the open/close of the contactor and its dynamic thermal stability. But when the overtravel is too large, the switching-on power of the operating mechanism would be increased, such that the switching-on will be very unreliable. Setting a suitable overtravel can provide the contactor with a proper contact pressure, thus ensuring a good contact.

Thus, the overtravel setting is critical to the performance of the contactor.

### SUMMARY

In actual products, there is an inconsistency in overtravel and contact pressure among the electrodes of the contactor, and the contact force at each of the electrodes is unbalanced and has a greatly wide range. In view of the above problems, the present utility model has developed a new type of adjustable contactor to adjust the contact pressure at each of the electrodes, such that an optimal contact force between the contacts is obtained, thereby reducing the bounce and increasing the electrical stability.

One embodiment according to the present utility model discloses a type of adjustable contactor, which comprises: a static contact fixed in the contactor; a movable contact which is connected in the movable contact bracket through a contact spring, and which makes contact with the static contact in accordance with the translational motion of the movable contact bracket in the contactor; the contactor further comprises adjusting knobs provided in the movable contact bracket at one end in connection with the contact spring while corresponding to the contact springs connected with individual movable contacts, the adjusting knob being set so that adjustment of the compression or release of the contact spring is achieved by rotating the adjusting knob so as to adjust the contact pressure of the movable contact.

The movable contact bracket has several movable contacts.

The overtravel of each contact spring and the bounce time of each movable contact is measured upon the pre-assembled contactor, and, the adjusting knob is operated so as to adjust the contact pressure of the contact spring, based on the measured overtravel value of each contact spring and the bounce time value of each movable contact.

The bounce time of each movable contact is re-measured after the completion of the operating the adjusting knob.

After the completion of re-measurement of the bounce time of each movable contact, the pull-in voltage threshold and the release voltage threshold of the contactor are tested.

The adjusting knob is connected to the contact spring by means of a helical structure.

The contactor of the present utility model has the following advantages:

A good contact between the movable contact and the static contact is achieved;

The inconsistency between the electrodes is eliminated, and the contact pressure at each of the electrodes is compensated so as to obtain a more balanced and stable connection;

The bounce occurred during the opening and closing of current is depressed, thus improving the electrical stability;

Depressing compact upon the movable contact, the static contact and the magnetic pole, thus improving the mechanical durability;

It is possible to increase the initial speed during power failure, thus improve the electrical stability performance.

### BRIEF DESCRIPTION OF THE DRAWINGS

The above and/or other aspects and advantages of the present invention will become more apparent and more readily appreciated from the following detailed description taken in conjunction with the accompanying drawings in which:

FIG. 1 is a schematic structural view of a contactor according to the present utility model;

FIG. 2 is a top view of the movable contact structure in a contactor according to the present utility model;

FIGS. 3 and 4 are schematic views showing the structure of the adjusting knob in a contactor according to the present utility model.

### DETAILED DESCRIPTION

By incorporating an adjusting knob structure in the movable contact, the present utility model thereby achieves an adjustment of the contact pressure to overcame the problem that various electrodes of a contactor tend to differ from each other in overtravel and contact pressure thereof.

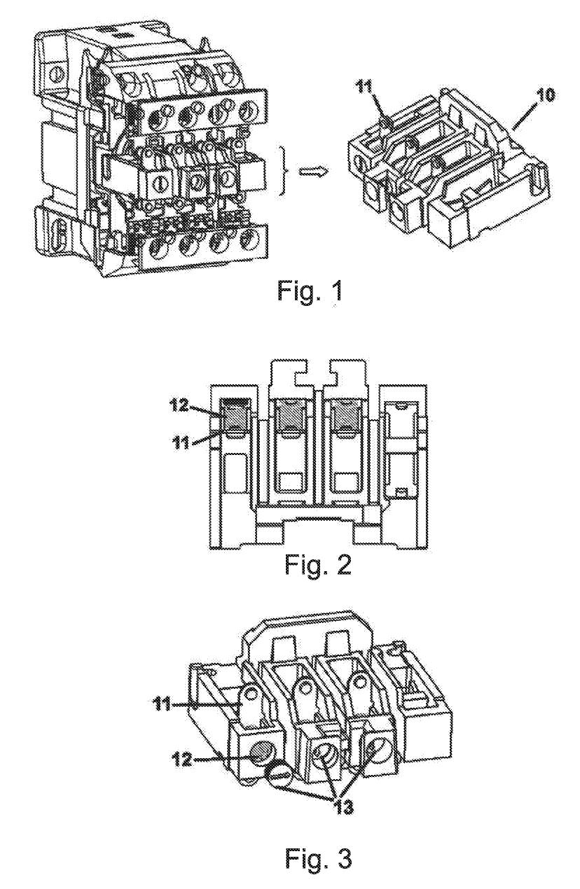

A brief description of the structure of a contactor will be made in conjunction with FIGS. 1-4 in the following.

Referring to FIG. 1, the movable contact 11 of the contactor makes a contact with the static contact fixed in the contactor by means of the translational motion of the movable contact bracket 10 within the contactor.

Referring FIG. 2, in the movable contact bracket 10, the movable contact 11 corresponding to each of the electrodes is connected to the movable contact bracket 10 through the contact spring 12. The movable contact 11 moves close to or away from the static contact of the contactor with the translational motion of the movable contact bracket 10. After the movable contact 11 is brought into contact with the static contact, along with further translational motion of the movable contact bracket 10 toward the static contact, the contact spring 12 located between the movable contact 11 and the movable contact bracket is compressed, thus establishing a contact pressure reacting upon the movable contact 11.

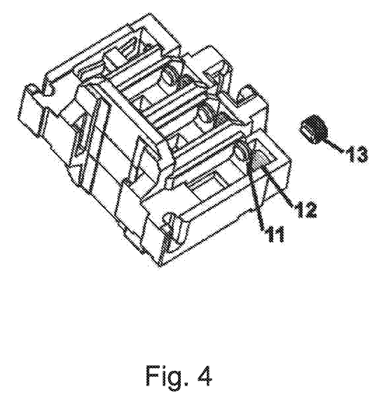

Referring to FIGS. 3 and 4, the contactor according to the present utility model adds an adjusting knob 13 for each of the electrodes. The adjusting knob 13 is arranged at the end where the movable contact bracket is connected with the contact spring 12, so that, by rotating the adjusting knob 13, the contact spring 12 varies in its length and thus an adjustment of the compression or release of the contact spring 12 can be achieved, thereby achieving an adjustment of the contact pressure applied to the movable contact 11. The adjusting knob 13 is connected to the movable contact bracket 10 by means of a helical structure for example, and then is connected to the contact spring 12, thereby achieving an adjustment of the compression or release of the contact spring 12. Here, the adjusting knob 13 can also be installed in other ways know in this art, so as to achieve an adjustment of the compression or release of the contact spring 12. By making adjustment to the adjusting knob 13 of different electrodes respectively according to the actual conditions of the contact pressure of the contact spring in distinct electrodes, it is possible to achieve the consistency of the contact pressure among different electrodes, and thus obtaining an improved stability about the close/open of the current.

In actual practice, step one is firstly performed, i.e., pre-assembling the contactor. In a conventional operation, when the contactor is pre-assembled, a test will be made to the pull-in voltage threshold and the release voltage threshold, and finally, the contactor will be subjected to fastening and integration. For the contactor according to the present utility model added with an adjusting knob 13 for adjusting the contact pressure, it is required to add the following steps after the pre-assembling. Step two: measuring the overtravel of each of the contact springs, thereby determining the contact pressure of each movable contact; step three: measuring the bounce time of each of the movable contacts; step four: based on the overtravel value of each contact spring and the bounce time value of each movable contact measured in steps two and three, operating the adjusting knob 13 to adjust the contact pressure of the contact spring 12, thereby achieving the consistency among the contact springs 12 of various electrodes; step five: after the completion of operating the adjusting knob, re-measuring the bounce time of each movable contact so as to obtain consistency among various contact springs. After the completion of the above related operation upon the contact pressure, a conventional operation step is performed, i.e., step six: testing the pull-in voltage threshold and the release voltage threshold, and finally fastening and integrating the contactor.

By adding an adjusting knob structure in the movable contact, the contactor according to the present utility model, merely through simple operations, achieves adjustment of the contact pressure of various electrodes, obtains an optimal contact force between the contacts, overcomes the problem that various electrodes in a contactor tend to be differ from each other in their overtravel and contact pressure, thereby improving the stability, electrical performance and lifespan of the contactor.

In the above, description has been made to the configuration, advantages and characteristics of the present utility model through specific embodiments. It is to be understood by those skilled in the art that the foregoing description is by way of example only but by no means to be limiting. Those skilled in the art could make various equivalent changes and substitutions without departing from the spirit and essential characteristics of the present utility model.

What is claimed is:

1. An adjustable contactor comprising:
a static contact fixed in the contactor;
a movable contact which is connected in the movable contact bracket through a contact spring, and which makes contact with the static contact in accordance with the movement of the movable contact bracket in the contactor;
characterized in that:
the contactor further comprises adjusting knobs provided in the movable contact bracket at one end in connection with the contact spring while corresponding to the contact springs connected with individual movable contacts, the adjusting knob being set so that adjustment of the compression or release of the contact spring is achieved by rotating the adjusting knob so as to adjust the contact pressure of the movable contact.

2. The contactor according to claim 1, characterized in that, the movable contact bracket has several movable contacts.

3. The contactor according to claim 1, characterized in that, measuring the overtravel of each contact spring and the bounce time of each movable contact upon the pre-assembled contactor, and operating the adjusting knob so as to adjust the contact pressure of the contact spring, based on the measured overtravel value of each contact spring and the bounce time value of each movable contact.

4. The contactor according to claim 3, characterized in that, re-measuring the bounce time of each movable contact after the completion of the operating the adjusting knob.

5. The contactor according to claim 4, characterized in that, after the completion of re-measurement of the bounce time of each movable contact, testing the pull-in voltage threshold and the release voltage threshold of the contactor.

6. The contactor according to claim 1, characterized in that, the adjusting knob is connected to the contact spring by means of a helical structure.
